(19) United States
(12) Patent Application Publication
(10) Pub. No.: US 2024/0427048 A1
(43) Pub. Date: Dec. 26, 2024

(54) AUTOMATED THIRD INTERFACE ECHO RECOGNITION USING A LARGE FOUNDATION MODEL

(71) Applicant: Schlumberger Technology Corporation, Sugar Land, TX (US)

(72) Inventors: Josselin Kherroubi, Clamart (FR); Kamaljeet Singh, Bucharest (RO); Salma Benslimane, Menlo Park, CA (US); Eya Ghamgui, Clamart (FR)

(21) Appl. No.: 18/746,341

(22) Filed: Jun. 18, 2024

Related U.S. Application Data
(60) Provisional application No. 63/509,068, filed on Jun. 20, 2023.

(51) Int. Cl. G01V 1/50; E21B 47/002; E21B 47/26

(52) U.S. Cl. CPC G01V 1/50; E21B 47/0025; E21B 47/26

(57) ABSTRACT

Embodiments presented provide for a detection of acoustic events during hydrocarbon recovery operations, such as during wireline investigations. In embodiments, an automated artificial intelligence method is used to analyze third interface echo events. Such analyzation allows operators to discriminate if the fluid within an annulus of the wellbore is a liquid, a solid or a gas.

### CROSS-REFERENCE TO RELATED APPLICATIONS

This application claims priority to and the benefit of U.S. Provisional Patent Application No. 63/509,068 entitled “Automation Third Interface Echo recognition using Large Foundation Model,” filed Jun. 20, 2023, the entire disclosure of which is hereby incorporated herein by reference.

### FIELD OF THE DISCLOSURE

Aspects of the disclosure relate to automatic detection of acoustic events that may occur during hydrocarbon recovery operations. More specifically, aspects of the disclosure relate to an automated artificial intelligence method to analyze third interface echo (TIE) events, thereby allowing operators to discriminate between a gas, a liquid and a solid in the annulus.

### BACKGROUND

Analysis of wellbore fluids and features is an ongoing challenge for operators and engineers in the hydrocarbon recovery industry. Often, in an effort to speed analysis of geological formations, different technologies are used. One such technology is the use of ultrasonic waveform generation and recording. In these technologies, ultrasonic waves are created through various technologies, such as downhole transducers. The ultrasonic waves are emitted from the transducers and then proceed to enter the localized geological stratum. When a defect or a disturbance in the geological stratum is encountered, the ultrasonic waves bounce or reflect off the defect or disturbance. The transducers in the downhole location identify the ultrasonic waves reflected. After the reflection, an interpretation of the signals received must be performed. The analysis of the signals is very time consuming and may be imprecise due to several factors. Improper reading of the reflected signals can cause engineers and operators to conclude incorrect features are present within the geological stratum.

Different types of echoes encountered can identify different possible changes in the geological structure. Often, a third interface echo event is used by engineers and operators to identify features of interest.

Recognition of TIE is typically performed by a domain expert. This is a long and interpreter dependent process. Such long processes are extremely expensive to perform. Accelerating or automating this task would allow for the reduction of the cost of operation and to enable the operator to focus on tasks requiring more expertise.

There is a need to provide apparatus and methods that are easy to operate in the field, wherein the resulting analysis of the data received from TIE signals is accurately identified.

There is a further need to provide apparatus and methods that do not have the drawbacks discussed above which can include expensive and time delayed results.

There is a still further need to reduce economic costs associated with analysis operations described above with conventional tools.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for analysis of wellbore data is disclosed. The method may comprise obtaining acoustic data related to a wellbore. The method may also comprise preparing an acoustical data image from the acoustic data obtained from the wellbore. The method may also comprise placing at least one positive data point on the acoustical data image. The method may also comprise placing at least one negative point based upon an assumed width of a third interface echo. The method may also comprise performing an analysis of data, as bounded by the negative, at least one negative point to identify a presence of a downhole third interface echo as well as the presence of a gas, a solid or a liquid at the downhole third interface echo through the use of a large foundation model.

In another example embodiment, an article of manufacture is disclosed. The article of manufacture may comprise a non-volatile memory, the non-volatile memory configured with a set of instructions that may be machine readable, the set of instructions comprising a method of obtaining acoustic data related to a wellbore. The method performed may also comprise preparing an acoustical data image from the acoustic data obtained from the wellbore. The method performed may also comprise placing at least one positive data point on the acoustical data image. The method performed may also comprise placing at least one negative point based upon an assumed width of a third interface echo. The method performed may also comprise performing an analysis of data, as bounded by the negative at least one negative point to identify a presence of a downhole third interface echo as well as the presence of a gas or a liquid at the downhole third interface echo through the use of a large foundation model.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are; therefore, not be considered limiting of its scope, for the disclosure may admit to other equally effective embodiments.

FIG. 1 illustrates differences in acoustic signal behavior in an anulus comparing a liquid filled anulus and a gas filled anulus.

FIG. 2 is a comparison of two logs for TIE behavior for a liquid filled annulus and a gas filled annulus.

FIG. 3 is a log illustrating bonded and nonbonded behavior with TIE and no TIE behavior.

FIG. 4 is an initial image to be used for analysis in one example embodiment of the disclosure.

FIG. 5 is an image for basic active leaning of FIG. 4 wherein the creation of positive points enables accurate delineations of the TIE.

FIG. 6 is an image of basic active learning (second example), when the reducing a number of points.

FIG. 7 is an image of basic active learning (third example) when creating three positive points, the algorithm starts to fail.

FIG. 8 is an image where negative points are automatically added on the sides of positive points.

FIG. 9 is an image illustrating that the method is still working with two points added on reflection data.

FIG. 10 is a depiction of three images wherein on the right, an initial annotation, on the left, automatic generation of positive and negative points and in the middle, the results of the analysis algorithm.

FIG. 11 is a depiction of four images where positive and imprecise points are created using basic thresholding.

FIG. 12 is a method for automated third interface echo recognition using a large foundation model in one example embodiment of the disclosure.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Example embodiments of the disclosure will now be disclosed. Embodiments of the disclosure provide for an automated third interface echo recognition system. In hydrocarbon recovery operations, it is often required to use an ultrasonic sensor array in order to test the local geologic structures outside of a wellbore. For deep wells, drilling an exploratory well to the depths required would be too expensive to determine local structures. An alternative to such activities is to place an array of transducers downhole or along a surface of a geological stratum and send ultrasonic signals into the stratum. Objects and defects in the stratum will cause reflections that may be captured by researchers. The data received from such sending and receiving techniques can provide expansive knowledge on the local geology. Unfortunately, while such activities are quick in field operational time, the post-testing phase is labor and cost intensive. Often, the wellbore project must be suspended, pending analysis of the data obtained. Aspects of the disclosure aim to provide real time solutions for analysis, without the need for an extensive post-testing phase, thereby increasing the overall economy and, ultimately, hydrocarbon production from the well. A method of automated detection of TIE (third interface echo event) is described. The method described allows the user to determine whether the material is a gas, liquid or solid. In some implementations, applications can be based on either Machine Learning methods or on conventional interpretation or a mixture of thereof.

As will be understood, recognition of TIE is typically performed by a domain expert trained in such analysis. This is a long and interpreter dependent process. Embodiments of the disclosure prevent the necessary use of such an expert, thereby accelerating or automating this task. This, in turn, allows to reduce the cost of operation and to enable the operator to focus on tasks requiring more expertise.

Aspects of the disclosure use a Large Foundation Model (LFM) for analyzing the data. One such model that is open source is a model called “Segment Anything”. As will be understood, other models may be used. Such models allow for accurate segmentation of data to find boundaries. Models of this type are especially effective when used with visual images. For example, a Large Foundation Model may be used to separate out a camouflaged animal in a picture where the background is confusingly similar to the animal. Such Large Foundation Models are pre-configured to identify like structures. Often, Large Foundation Models are pre-trained on millions of images, allowing for accurate analysis of visual data. Using such a model may not require any user training (zero shot learning) and enables active annotation to manage the generalization of the solution. As will be understood, however, the model may be trained or retrained, as needed.

One example of the disclosure is to discriminate the gas in the annulus (or dry debonded cement) from the liquid annulus. The difficulty in analysis of this situation is that both states have a low acoustic impedance. Example values of the low acoustic impedance are as follows:
1. Gas: 0-0.3 MRayl
2. Liquids: 0.8+ MRayl

Due to such similarities in values of impedance, and the required precision to make a correct analysis, for Pulse-Echo interpretation, gas and liquid could quite often be confused. Even more problematic is the tool calibration step, a so-called free-pipe normalization, where inaccurate settings in the tool may produce results that confuse interpreters.

Setting tools to inaccurate settings can be problematic during free-pipe normalization procedures. In these scenarios, the tool could be wrongly programmed to detect liquid when, in fact, there is the presence of gas. That situation can lead to a systematic positive bias of more than 1 MRayl and to the misinterpretation of the well integrity situation.

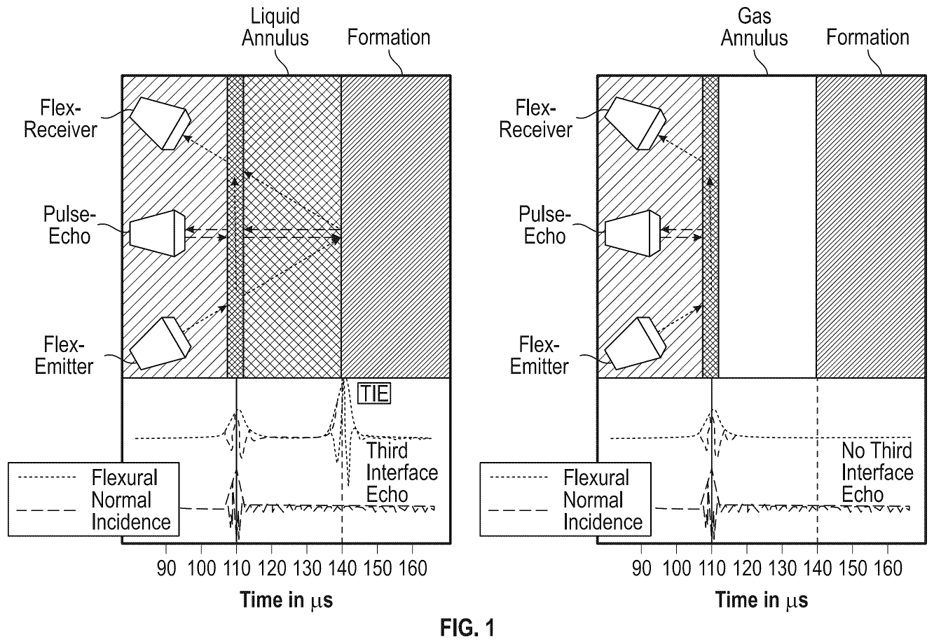

In some types of ultrasonic field activities, both Pulse-Echo responses and Flexural waves are used for analysis. The use of flexural waves generates additional formation reflection echoes (aka third interface echoes or TIE). Referring to FIG. 1, a liquid filled annulus is shown in the left frame with? no TIE in case of gas-filled annulus.

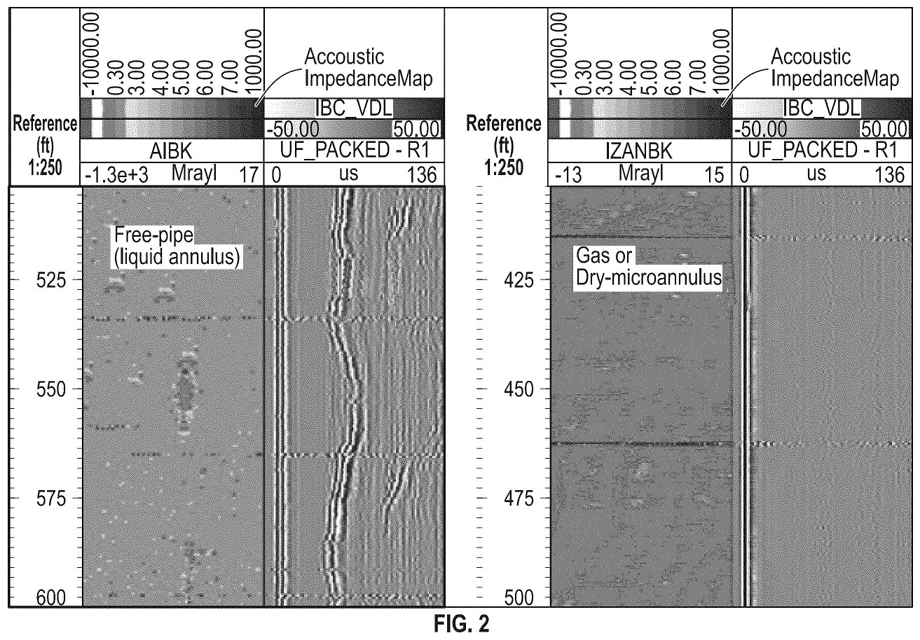

To help in obtaining results, an important observation to the TIE in liquid annuli is the ultrasonic data trace, which is well pronounced and (generally) is far apart from the main flex wave echo. Referring to FIG. 2, these two situations (gas/liquid) are visible. Thus, it is possible to distinguish liquid and gas in these situations. In further situations, models can be established to distinguish liquid and gas, thereby allowing for quick and accurate representation of as-tested field conditions.

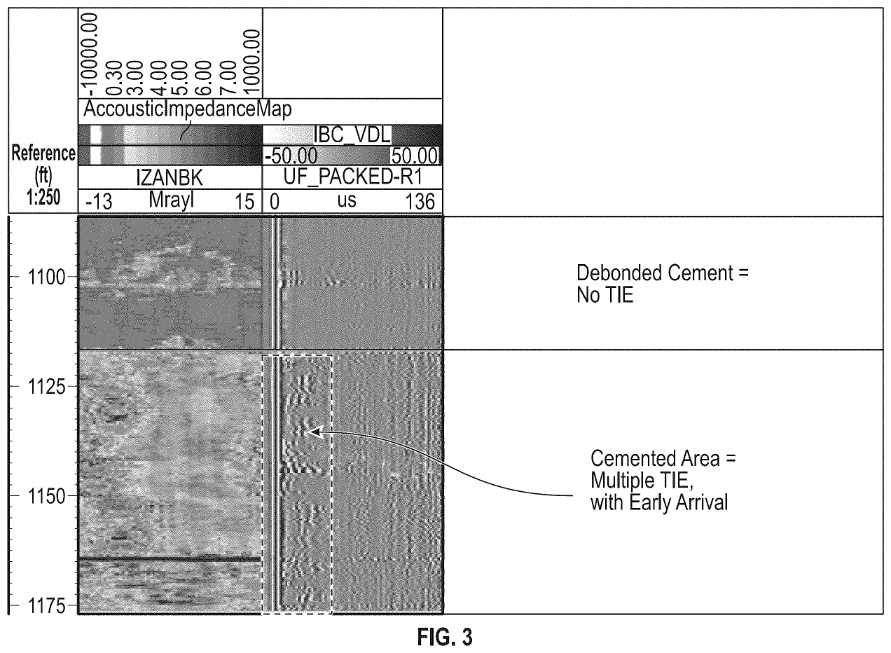

In an instance of the positioning of a cemented area (solid material), for instance around a wellbore, the TIE can also be found. The trace is not as clear; however, and the echo not far apart from the main flex echo as in the situation of the liquid annulus. This situation is illustrated in FIG. 3.

Pursuant to the above, the presence of the TIE allows for discrimination between the three situations previously described. For analysis purposes, in embodiments, an automatic procedure is provided to discriminate between the situations, described above. TIE detection, however, is not a trivial task, due to the presence of the parasitic signals received during the initial data recordation stage from field activities. In embodiments, the ability of the Large Foundation Model helps distinguish the possible scenarios and allows for quick and accurate identification of features.

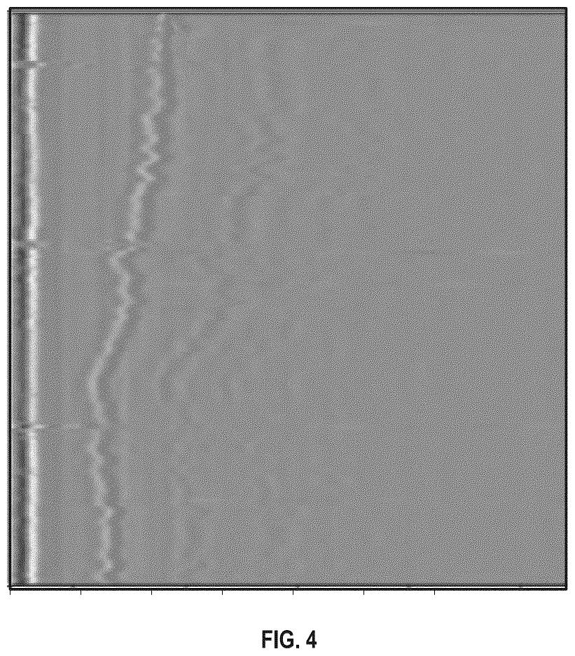

An example image used for analysis is provided in FIG. 4. The image in FIG. 4 is generated from ultrasonic data received from the field. As described above, the data may be generated from flexural waves and pulse-echo responses. It is desired to quickly and efficiently identify the presence of TIE without the need for extensive calculations and further analysis. Determining the presence of TIE allows researchers the ability to know if gas, solid or liquid is present.

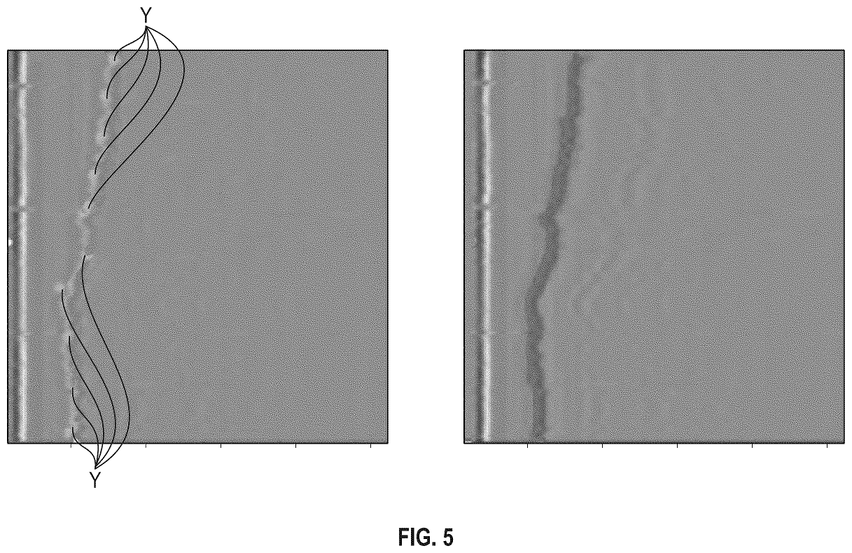

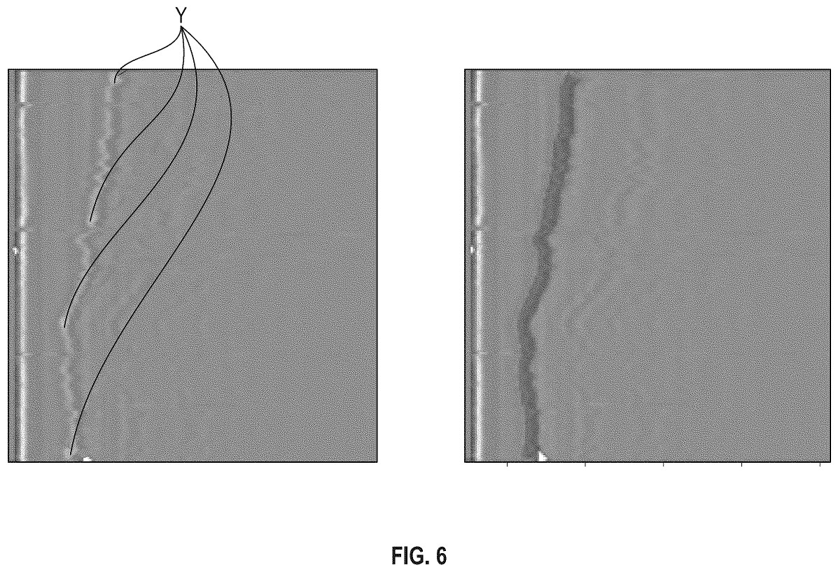

Basic active annotation is achieved in the step after generating the ultrasonic data image as in FIG. 4. Referring to FIG. 5, an annotated image is created by placing positive points in an area that analysis would segment. Such segmentation is achieved, for example, along the major line running from the top of the page to the bottom of the page. This line indicates the most probable line where TIE exists. Positive points are achieved, in one non-limiting embodiment, through placement of a yellow dot on the graph. The yellow dots are annotated with the symbol Y for easy identification. For ease of placing the yellow dots on the graph, a graphical input may be made through a left mouse click on the area of interest. Referring to FIG. 6, an annotated image is illustrated with a lesser number of graphical inputs, thereby saving user time.

After the basic annotation of the positive points of the image, a bounding or negative set of points must be placed for limiting the analysis between a first negative point and a second negative point. To achieve this, similar to the positive point identification, negative points are added to the image, thereby bounding the analysis. Negative points are added and shown by red points. For ease of placement, through action of a computer mouse, a right click may be used to locate the positions for the negative points. For definition, a negative point is a point in a region outside a cutting, thus the negative points can be used to restrict the area where TIE should be segmented. As will be understood, instances where points are incorrectly placed on the FIG. may be erased/removed. Such removal may be made through, for example, hitting a backspace key. In order to command that the analysis start, the enter key may be used to start segmentation.

The above approach accelerates much of the tasks required for the analysis. For example, the placement of the negative points allows for bounding of the analysis, reducing the amount. In this embodiment, the image requires, 3*3=9 clicks (3 clicks for each depth as each segment adds 1 positive and 2 negative points). Analysis may proceed, through use of the Large Foundation Model, to whether TIE is present and, correspondingly, whether liquid or gas is present.

If only positive points are added, analysis may continue; however, the analysis performed will be relatively unbounded. Referring to FIG. 6, an example of this is illustrated where four (4) points are added.

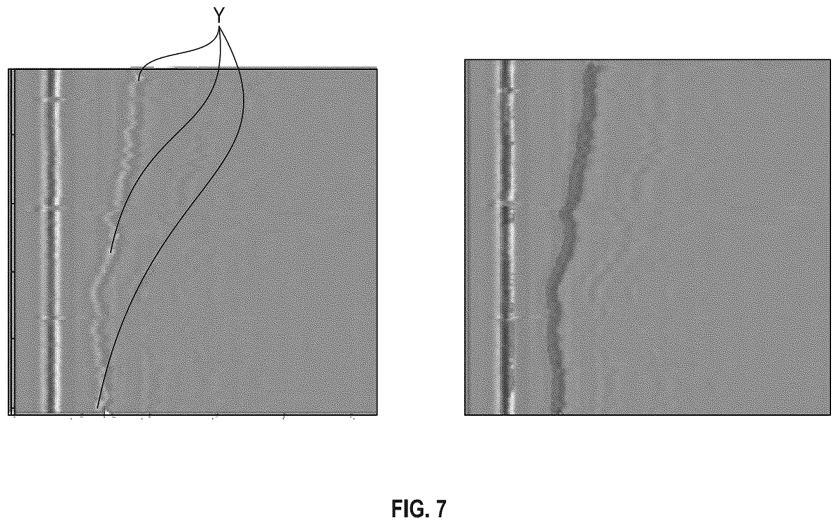

Aspects of the disclosure seek to minimize the number of clicks used for identification of positive points as well as negative bounding points. Referring to FIG. 7, three points are used in an attempt to allow segmentation for those specific points. As can be seen in FIG. 7; however, the reduction to three (3) points does have some difficulty wherein resultant data is not consistent with the results obtained in FIG. 5.

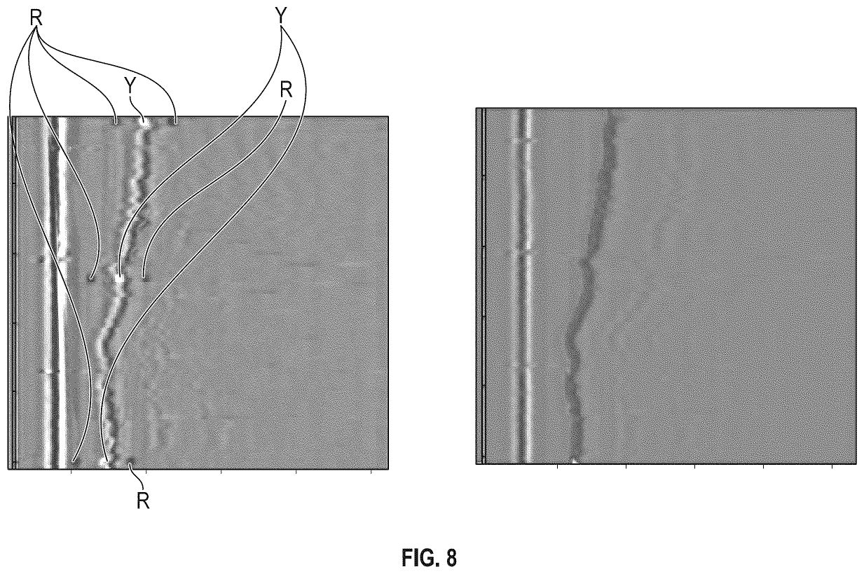

While aspects above allow for analysis of wellbore sections, it still may be desired to further speed analysis. In this embodiment, placement of the negative points bounding the analysis may be achieved by knowing the approximate width of the TIE. Approximate widths of a TIE may be achieved through data retrieval on other completed projects where similar results have been achieved. Thus, placement of a positive point is automatically followed by automatic placement of negative points, thereby bounding the overall analysis. Referring to FIG. 7, a three positive point identification is followed by three sets (total of 6 points) of negative points automatically placed per the known approximate width. Referring to FIG. 8, the number of positive point identification can be cut to 2 with minimal adverse results.

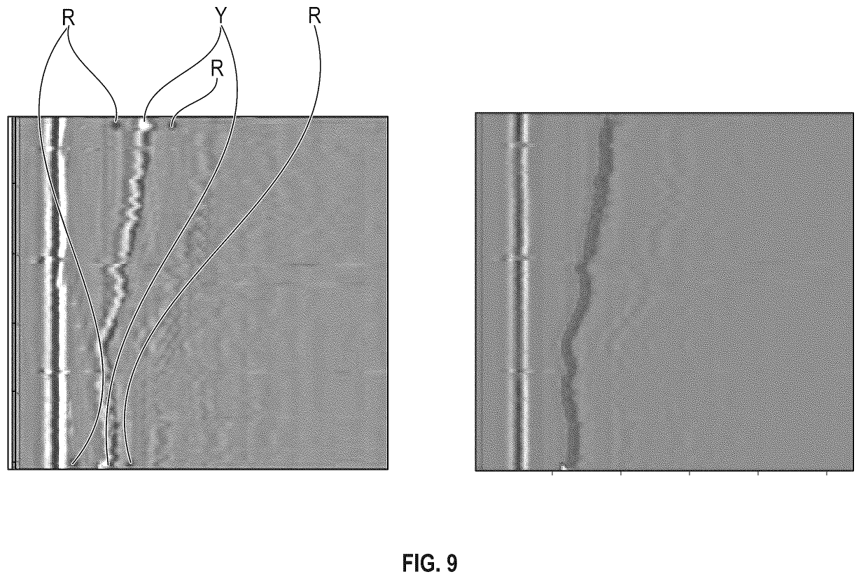

As described above, a section of a wellbore may be annotated/interpreted for TIE. As will be understood, it may be advantageous to annotate/interpret an entire wellbore, similar to the sections described above. In one example embodiment, a method to interpret the whole well with a minimum number of clicks is illustrated. In this embodiment, referring to FIG. 9, the user zooms video representation out to have an overview of the whole well. The user then clicks on one TIE; the Large Foundation Model will then look to any well, correlated signature and add positive points and segment the well. The positive points are displayed with their associated negative points considering the maximum extent of the TIE. As with the above, the negative points may be created based upon knowing the approximate width of the TIE. Also, as with the previous analysis, the addition of the negative points essentially constrains the amount of data needed to be processed.

As will be understood, a user may delete/create positive points. Points may be added iteratively. Each time a user deletes or creates new points, the segmentation occurring from the large foundation model is updated.

In embodiments, it is previously assumed that the logs were not interpreted and that annotations were needed for bounding the analysis. Another example embodiment of the disclosure is to improve and to increase the consistency of existing database with annotations.

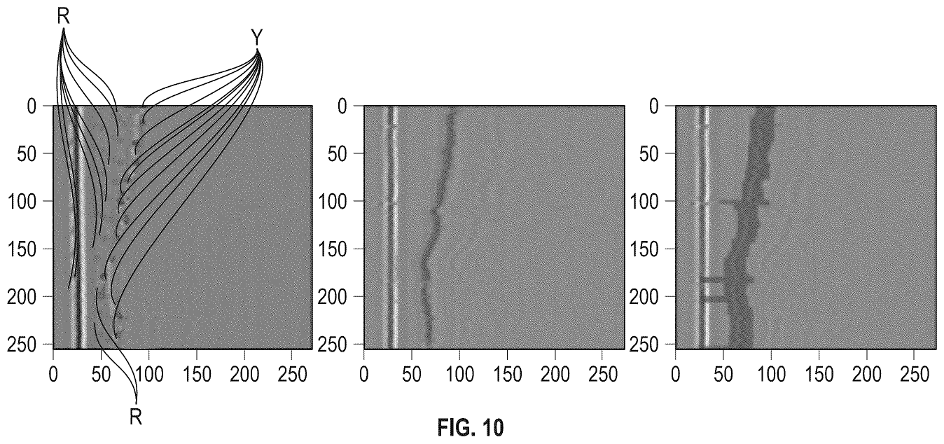

As illustrated in FIG. 10, a possibility to handle and improve the interpretation without user effort may be achieved. From a mask interpretation of a model expert, positive points are automatically generated at the middle of each mask (for each line containing annotation, the middle column of the mask is noted for positive points) and negative points from both sides of the mask (with some margin). The segmentation is then launched and the data evaluated.

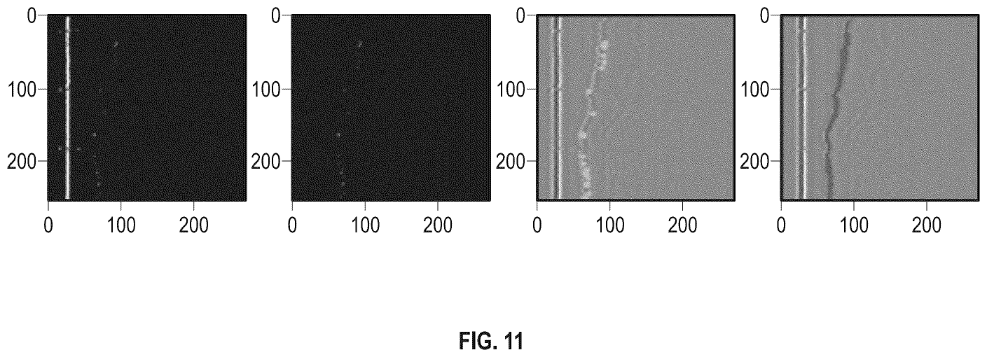

In other embodiments, is it proposed to only select points that are very likely to be TIE and then use these points as a positive point. Referring to FIG. 11, an example is shown, where a threshold is applied and a first break arrival is removed (with domain expertise).

This method may be improved by using other types of algorithms. As an example, it could be a ML/DL segmentation model where a high threshold may be imposed on the final confidence factor to be sure to select correct points.

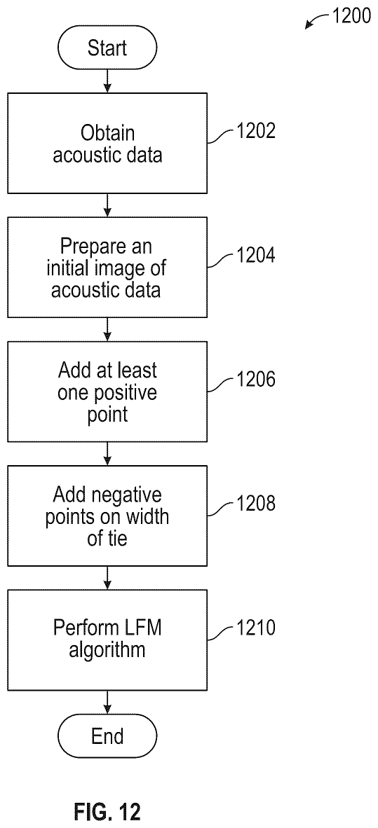

Referring to FIG. 12, a method 1200 is illustrated in conformance with one example embodiment of the disclosure. At 1202, acoustical data is obtained from a wellbore or wellsite. As previously noted, the acoustical data may be pulse echo data, flexural wave data or a combination of both. At 1204, an initial image of the acoustical data obtained in 1204 is rendered on a video screen. For analysis, at least one positive point along the data is placed for identification at 1206. The “at least one positive point” is placed according to a Large Foundation Model used for analysis of the data. The Large Foundation Model may be a pre-trained model. In other embodiments, the Large Foundation Model may not be pre-trained model. At 1208, at least one negative point is located a preset amount of distance from the positive point placed at 1206. In some embodiments, two negative points are used to delineate bounds for analysis. After the bounding has been performed, data from the acoustic data is placed within the LFM model for analysis. As previously described, the model may be pretrained or not pretrained. The resulting data obtained from the model identifies the conditions within the geological stratum, such as if there is a liquid phase near the wellbore or if there is a gaseous phase. Additionally, the data may indicate if there is a bonded or debonded concrete structure near the wellbore.

As will be understood, the method described above may be performed on a personal computer, a cloud-based computer system and a computer server, as non-limiting embodiments. The annotation of the acoustical figures described above may be performed at the wellsite or at a centralized location. In some implementations, a computer readable non-volatile memory may be configured with programmable instructions to perform on a computer. The method, as described above, may be placed on the non-volatile memory. In non-limiting instances, the article of manufacture containing the non-volatile memory may be a compact disk, a universal serial bus memory, a secure digital card or other similar arrangement.

In embodiments, the Large Foundation Model may be retrained, at times, if accuracy is not sufficient for the needs of the user. Databases of known acoustical data from previously completed projects may be used in the training process. The model may be equipped with a feedback loop to allow for selection criteria and calculation performance to be updated, as needed. As will be understood, different models may be generated and used for different purposes. For example, a specific model may be identified as being extremely accurate for analysis in one type of environment, but may be less accurate in another environment. To this end, the model used may be very specific to the area of interest and further models may be used for other situations. Embodiments of the disclosure provide herein for use of multiple models. Additionally, artificial intelligence may be used for all user inputs, as necessary, fully automating the process of analyzing the acoustic data.

Additional areas of usage of the large foundation model may include the model being used as a quality assurance technique that supplements manual analysis by a human. In such a capacity, the ability of the model to independently verify the accuracy of quantification of structures performed by an expert may limit the number of mistakes and potential accidents from incorrect analysis.

Example embodiments of the disclosure are presented next. The example embodiments disclosed should not be considered limiting. In one example embodiment, a method for analysis of wellbore data is disclosed. The method may comprise obtaining acoustic data related to a wellbore. The method may also comprise preparing an acoustical data image from the acoustic data obtained from the wellbore. The method may also comprise placing at least one positive data point on the acoustical data image. The method may also comprise placing at least one negative point based upon an assumed width of a third interface echo. The method may also comprise performing an analysis of data, as bounded by the negative at least one negative point to identify a presence of a downhole third interface echo as well as the presence of a gas or a liquid at the downhole third interface echo through the use of a large foundation model.

In another example embodiment, the method may be performed wherein the acoustic data includes flexural data.

In another example embodiment, the method may be performed wherein the acoustic data includes pulse-echo data.

In another example embodiment, the method may be performed wherein the placing the at least one negative point based upon an assumed width of the third interface echo includes two negative points.

In another example embodiment, the method may be performed wherein the in preparing an acoustical data image from the acoustic data obtained from the wellbore.

In another example embodiment, the method may be performed wherein the large foundation model is pretrained.

In another example embodiment, the method may be performed wherein the large foundation model is not pretrained.

In another example embodiment, the method may be performed wherein the preparing of the acoustical data image from the acoustic data obtained from the wellbore has previously occurred.

In another example embodiment, the method may be performed wherein the preparing of the acoustical data image from the acoustic data obtained from the wellbore has previously occurred and has previously been annotated.

In another example embodiment, the method may be performed wherein the placing of the at least one positive data point is through an automated algorithm.

In another example embodiment, the method may be performed wherein the method is performed at a wellsite.

In another example embodiment, the method may be performed wherein the method is performed at a location remote from the wellsite.

In another example embodiment, an article of manufacture is disclosed. The article of manufacture may comprise a non-volatile memory, the non-volatile memory configured with a set of instructions that may machine readable, the set of instructions comprising a method of obtaining acoustic data related to a wellbore. The method performed may also comprise preparing an acoustical data image from the acoustic data obtained from the wellbore. The method performed may also comprise placing at least one positive data point on the acoustical data image. The method performed may also comprise placing at least one negative point based upon an assumed width of a third interface echo. The method performed may also comprise performing an analysis of data, as bounded by the negative, at least one negative point to identify a presence of a downhole third interface echo, as well as the presence of a gas or a liquid at the downhole third interface echo through the use of a Large Foundation Model.

In another example embodiment, the article of manufacture may be in a form of one of a compact disk, a universal serial bus arrangement and a secure digital card.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for analysis of wellbore data, comprising:
obtaining acoustic data related to a wellbore;
preparing an acoustical data image from the acoustic data obtained from the wellbore;
placing at least one positive data point on the acoustical data image;
placing at least one negative point based upon an assumed width of a third interface echo; and
performing an analysis of data, as bounded by the negative at least one negative point to identify a presence of a downhole third interface echo as well as the presence of a gas, a solid or a liquid at the downhole third interface echo through the use of a Large Foundation Model.

2. The method according to claim 1, wherein the acoustic data includes flexural data.

3. The method according to claim 1, wherein the acoustic data includes pulse-echo data.

4. The method according to claim 1, wherein the placing the at least one negative point based upon an assumed width of the third interface echo includes two negative points.

5. The method according to claim 1, wherein the in preparing an acoustical data image from the acoustic data obtained from the wellbore.

6. The method according to claim 1, wherein the large foundation model is pretrained.

7. The method according to claim 1, wherein the large foundation model is not pretrained.

8. The method according to claim 1, wherein the preparing of the acoustical data image from the acoustic data obtained from the wellbore has previously occurred.

9. The method according to claim 1, wherein the preparing of the acoustical data image from the acoustic data obtained from the wellbore has previously occurred and has been previously been annotated.

10. The method according to claim 1, wherein the placing of the at least one positive data point is through an automated algorithm.

11. The method according to claim 1, wherein the method is performed at a wellsite.

12. The method according to claim 1, wherein the method is performed at a location remote from the wellsite.

13. An article of manufacture comprising a non-volatile memory, the non-volatile memory configured with a set of instructions that is machine readable, the set of instructions comprising a method of:
obtaining acoustic data related to a wellbore;
preparing an acoustical data image from the acoustic data obtained from the wellbore;
placing at least one positive data point on the acoustical data image;
placing at least one negative point based upon an assumed width of a third interface echo; and
performing an analysis of data, as bounded by the negative at least one negative point to identify a presence of a downhole third interface echo as well as the presence of a gas or a liquid at the downhole third interface echo through the use of a Large Foundation Model.

14. The article of manufacture according to claim 13, wherein the article is of a form of one of a compact disk, a universal serial bus arrangement and a secure digital card.
